(19) United States
(12) Patent Application Publication
(10) Pub. No.: US 2014/0297322 A1
(43) Pub. Date: Oct. 2, 2014

(54) METHOD AND APPARATUS FOR DELAYING PROPAGATION OF PATIENT HEALTHCARE DATA

(71) Applicant: McKesson Financial Holdings, Hamilton (BM)

(72) Inventor: Brian Adams, San Leandro, CA (US)

(21) Appl. No.: 13/854,062

(22) Filed: Mar. 30, 2013

(51) Int. Cl. G06F 19/00

(52) U.S. Cl. CPC G06F 19/322
USPC 705/3

(57) ABSTRACT

A method, apparatus and computer program product are therefore in order to provide delayed propagation of patient healthcare data. In this regard, methods, apparatuses, and computer program products may operate to control propagation of healthcare data for a delay period to ensure the accuracy of received medical data. This delay period may function to allow a record keeper to identify and correct any errors associated with the patient healthcare data. The delay period may be dynamic and configurable based on characteristics of the patient healthcare data. The delay period may be adjusted such that a threshold percentage of modifications are captured during the delay period. In some embodiments, the delay period may be associated with particular record characteristics, such as the record keeper that provided the record, a medical specialty associated with the record, patient demographic information, or the like.

### TECHNOLOGICAL FIELD

Example embodiments of the present invention relates generally to health information systems, and, more particularly, to a method and apparatus for exchanging medical record information using a health information infrastructure.

### BACKGROUND

Advances in technology have led to the ability to access and share information more easily than ever before. It is increasingly common for individuals and companies to store their information in an electronic format, providing for easy sharing and archiving, and reducing the need for physical records. In particular, the ability to store medical records in an electronic format has the potential to revolutionize patient care by facilitating easy access to patient information among medical practitioners, users, healthcare organizations, and the like. However, the unique requirements for maintenance of electronic medical records have created challenges to implementation of electronic record storage and sharing systems.

One implementation of an electronic record storage and sharing system is the health information exchange. These exchanges provide for the ability to share a patient's medical records across the various health organizations and practitioner offices that participate in the exchange. Sharing of patient records in this manner allows for medical practitioners at a first institution to easily and efficiently determine what care and treatment the patient has received from other institutions. However, propagating records across multiple provider record systems may introduce new challenges. When transferring healthcare data between provider record systems, existing standards and protocols do not account for the possibility that the data may contain errors. For example, practitioners may accidentally enter incorrect patient data and therefore associate the record with an incorrect patient, or incorrect procedure or diagnosis codes may be entered into the record, resulting in an inaccurate medical history for the patient. Once these records are provided to the exchange, it may be difficult to correct such erroneous records that have already propagated to other provider systems, even if corrections are made. As a result, there is an unacceptably high likelihood that record systems that subscribe to patient healthcare data from other providers will contain incorrect patient data.

### BRIEF SUMMARY

A method, apparatus and computer program product are therefore provided according to example embodiments of the present invention in order to provide delayed propagation of patient healthcare data. In this regard, methods, apparatuses, and computer program products of example embodiments may operate to control propagation of healthcare data for a delay period to ensure the accuracy of received medical data. This delay period may function to allow a record keeper that provided the data to identify and correct any errors associated with the patient healthcare data. The delay period may be dynamic and configurable based on characteristics of the patient healthcare data. Embodiments may function to determine the frequency of modifications for sets of patient health data, and the delay period may be adjusted such that a threshold percentage of modifications are captured during the delay period, in order to reduce the likelihood of propagation of erroneous healthcare data to provider systems. In some embodiments, the delay period may be associated with particular record characteristics, such as the record keeper that provided the record, a medical specialty associated with the record, patient demographic information, or the like. Embodiments may further provide for an override of the delay period for certain types of healthcare data or based on manual user input.

Some example embodiments may include a method. The method may include receiving a set of patient healthcare data from a first record keeper, determining at least one characteristic of the patient healthcare data, determining, using a processor, a propagation delay for the patient healthcare data based on the at least one characteristic, and propagating the set of patient healthcare data to at least one second record keeper after the propagation delay has expired.

Some example embodiments may include an apparatus. The apparatus may include processing circuitry configured to receive a set of patient healthcare data from a first record keeper, determine at least one characteristic of the patient healthcare data, determine a propagation delay for the patient healthcare data based on the at least one characteristic, and propagate the set of patient healthcare data to at least one second record keeper after the propagation delay has expired.

Some example embodiments may include a computer readable storage medium. The computer readable storage medium may include instructions that, when executed by a processor, cause the processor to receive a set of patient healthcare data from a first record keeper, determine at least one characteristic of the patient healthcare data, determine a propagation delay for the patient healthcare data based on the at least one characteristic, and propagate the set of patient healthcare data to at least one second record keeper after the propagation delay has expired.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a block diagram of an example of a network infrastructure in accordance with example embodiments of the present invention;

FIG. 3 is an illustration of a record data flow incorporating a propagation delay in accordance with example embodiments of the present invention;

FIG. 4 is an illustration of a record data flow involving a correction of a record in a system employing a propagation delay in accordance with example embodiments of the present invention;

FIG. 5 is a flow diagram of an example of a method for implementing a propagation delay in a medical record system in accordance with example embodiments of the present invention; and

FIG. 6 is a flow diagram of an example of a method for determining a propagation delay in a medical record system in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in accordance with an example embodiment of the present invention in order to provide for propagation delay of patient healthcare data. In this regard, a method, apparatus and computer program product of an example embodiment may receive messages that include requests to add, modify, or delete patient healthcare data managed by a records system, such as a health information exchange. These messages may be processed using a propagation delay to allow the record keeper that sent the request time to edit, modify, or remove the request prior to propagation of the change to other record keepers. For example, a delay period of 30 seconds, 15 minutes, one hour, one day, or one week may be imposed prior to propagation of healthcare data to other record keepers. It should be appreciated that any length of such delay could be employed based on the delay periods deemed to have the most efficacy by the system or operators of the system. In some embodiments, the delay may be dynamically configurable to minimize the propagation of erroneous data while also minimizing the delay in propagating the data to other record keepers. Embodiments may further provide for detection of modification, edit, and delete messages associated with previously provided records to gather analytic data for configuration of the propagation delay. The system may employ different propagation delays for records with different characteristics. For example, records that are determined to have a higher likelihood of error may be associated with a longer propagation delay than records which are rarely corrected.

The term “record keeper” should be understood generally to refer to any individual or group that may request or provide access to patient healthcare data. This may include, but is not limited to, hospitals, physicians, patients, nurses, insurance companies, archives, government agencies, healthcare administrators, or any other provider, payer, or computer system maintained or operated by any of these entities. The term “record keeper” does not require or imply that the entity necessarily has record storage capabilities or will otherwise maintain any received records, although said entity may in fact possess such capabilities. Rather, this term is used merely to indicate the ability to participate in the exchange of patient healthcare data.

The terms “propagation”, “propagate”, and “propagating” should be understood to include any implementation or embodiment that provides access to healthcare record data by record keepers other than the record keeper that uploaded the healthcare record data, not just record keepers that actually receive a transmission including the record data or access said healthcare record data. For example, the act of enabling access to healthcare record data for particular record keepers may constitute propagation to those particular record keepers, even if those particular record keepers do not explicitly retrieve or otherwise access the propagated healthcare record data. As such, propagation of the record data may not actually require reception by other record keepers.

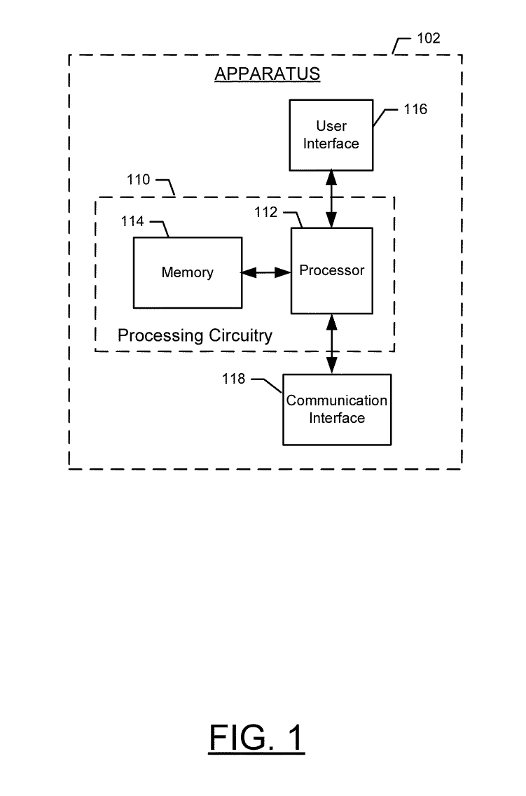

FIG. 1 illustrates a block diagram of an apparatus 102 in accordance with some example embodiments. The apparatus 102 may be any computing device capable of functioning in a health information infrastructure, including desktop or laptop computers, mobile devices, tablet computers, servers, or the like. In some particular embodiments, the apparatus 102 may be configured to provide access to patient healthcare data via a user portal. For example, the apparatus 102 may be implemented on a computing device that may be configured to receive a patient identity, and to access and display records associated with the patient identity via a display. Additionally or alternatively, the apparatus 102 may be configured to provide a health information system operable to receive and process patient healthcare data queries as described herein. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

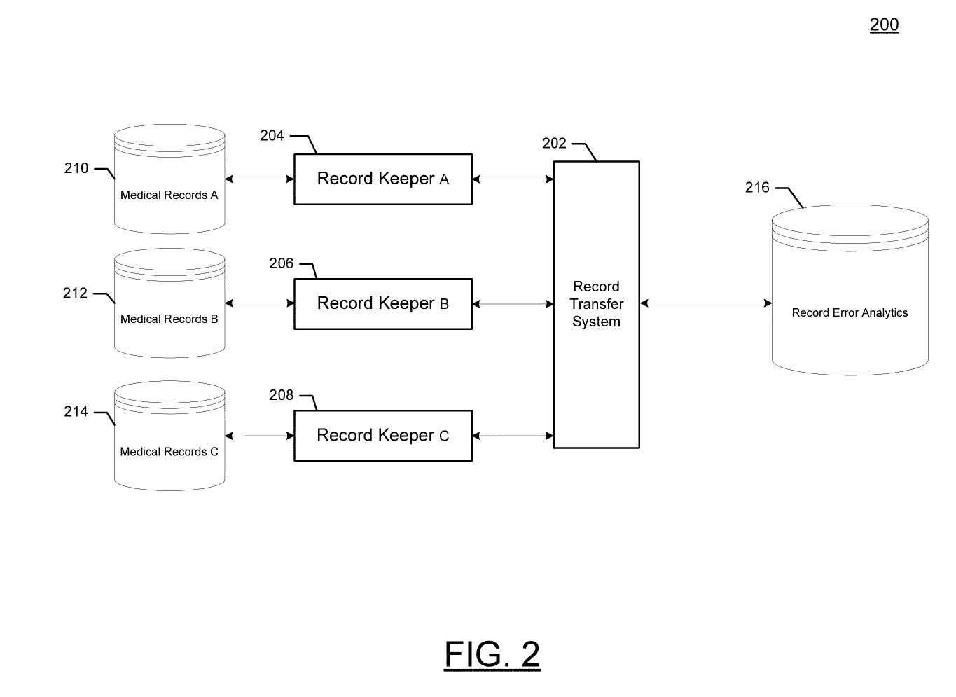

FIG. 2 is a block diagram of an example network infrastructure 200 in accordance with example embodiments of the present invention. The example network infrastructure 200 includes a record transfer system 202 in communication with one or more medical record keepers 204, 206, 208. The record transfer system 202 may function to implement searching, retrieval, and/or access to patient healthcare data maintained by the medical record keepers 204, 206, and 208. The record transfer system 202 may provide for propagation of healthcare data provided from a first one of the record keepers 204, 206, 208, to a second one or more of the record keepers 204, 206, 208. For example, the record transfer system 202 may be operable to publish received healthcare data to other record keepers that are in communication with the record transfer system 202. The record transfer system 202 may be embodied in one or more apparatuses, such as the apparatus 102 described with respect to FIG. 1.

The record transfer system 202 may function to provide an exchange of healthcare records data maintained by a plurality of medical record keepers. The example network infrastructure 200 depicts three medical record keepers, record keeper A 204, record keeper B 206, and record keeper C 208. For example, the record keepers may include healthcare organizations such as hospitals, physician's offices, medical imaging facilities, or the like. Record keepers may provide access to patient healthcare data to the record transfer system 202 and thus other record keepers for any particular reason in order to provide better access to data and clinical outcomes to patients, or for any other appropriate reason. The record transfer system 202 may thus provide an interface for publication, aggregation, and/or searching of patient healthcare data maintained by the associated record keepers. Although the example network infrastructure 200 depicts the patient healthcare data as maintained in separate datastores 210, 212, 214 associated with the individual record keepers 204, 206, 208, healthcare records may also be maintained in a central store accessible by the record transfer system 202, or in a cloud storage environment accessible to one or more of the record transfer system 202 or the record keepers 204, 206, 208. For example, although embodiments describe propagation to other record keepers, this propagation could include finalizing records stored locally to the record transfer system such that the finalized records are then accessible to the other record keepers.

The record keepers 204, 206, 208 may access the record transfer system 202 via a portal interface or application programming interface (API). For example, each record keeper may implement one or more applications for facilitating access to patient healthcare data. These applications may implement an API to send and receive requests for patient healthcare data to the record transfer system 202. Additionally or alternatively, the record transfer system 202 may provide direct access via a portal application (e.g., a web browser interface).

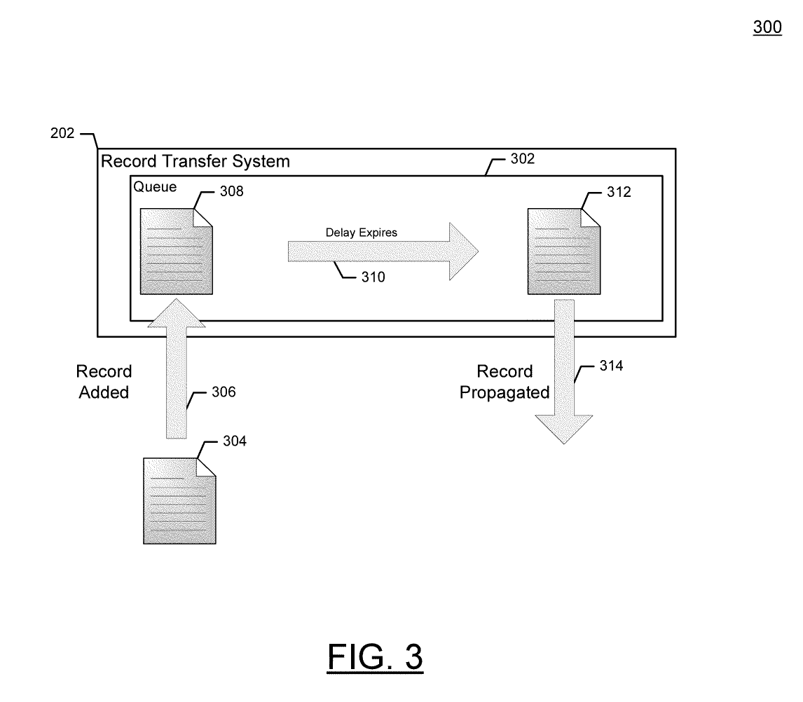

The record transfer system 202 may function to facilitate the publication, propagation, transfer, and/or conveyance of healthcare data across the record keepers 204, 206, 208. The record transfer system 202 may further implement a delay system to allow for editing, correction, deletion, or other modification of record data after the record data is provided to the record transfer system 202, but before the record data is provided to other record keepers. For example, a user at one of the record keepers may accidentally assign a set of record data to an incorrect patient, but correct the error at a later time. If the correction is provided to the record transfer system 202 before the record data is propagated to other record keepers, the record transfer system 202 can edit the record data and prevent transmission of erroneous data. Embodiments of a data flow and method for providing such a propagation delay are described further below with respect to FIGS. 3-5.

The duration of the propagation delay may be configurable or dynamically adjusted to maximize the ability of the record transfer system 202 to correct errors prior to propagation to other record keepers, while also minimizing the delay in providing the records to other record keepers. In this regard, the record transfer system 202 may identify when errors are detected and corrected in records provided to the record transfer system 202. To perform this monitoring, the record transfer system 202 may monitor for particular messages or message types associated with correction of data. For example, the record transfer system 202 may operate to identify a particular type of patient administration message associated with a correction of a record (e.g., a particular HL7 administration message type), and to determine the elapsed time between when the original record data was provided and when the correction message was received. The record transfer system 202 may function to determine the length of the propagation delay based on this elapsed time. For example, the record transfer system 202 may be configured to delay propagation of the records data for long enough that a certain threshold of corrections are received during the propagation delay. As such, the propagation delay may be configured to catch 90%, 95%, or 99% of correction messages.

The characteristics of particular record data may also be used to determine the propagation delay. For example, propagation delays may be associated with particular record keepers (e.g., some hospitals may have a higher error rate than others, or some physicians may tend to catch errors faster than others), particular record types (e.g., records associated with emergency rooms may tend to have higher error rates due to the faster paced environment, or errors may be made less frequently in practices that demand higher accountability, such as surgery), particular demographics (e.g., patients with particularly common names may be associated with higher error rates), or the like.

Data for record correction rates and delays for different records may be captured and stored in a set of record error analytics 216. These record error analytics 216 may be used to configure the duration of the propagation delay to minimize the delay while maximizing the likelihood that errors will be corrected before propagating the record data to other record keepers. The record transfer system 202 may thus be configured to identify trends and commonalities among different record types, and the propagation delay may be adjusted based on the characteristics of the particular record data being received. In some embodiments, the record transfer system 202 may employ a machine learning algorithm to identify correlations between record data, error rates, and the rate at which errors are corrected, such that the system automatically and dynamically adjusts the propagation delay as appropriate.

As the body of record error analytics data 216 grows, matures, and is analyzed over numerous search operations, various reports may be generated and used to improve error correction and to provide users of the system with data. The record error analytics 216 may identify patterns in record errors for particular record keepers or patient types, and provide feedback to users in the event that a record associated with a high error rate is provided. For example, if a patient has a particularly common name which has resulted in numerous corrections in the past, the record transfer system 202 may provide feedback to a user to ensure the user double-check the patient's information before sending. Various other reports and functionality may be employed to reduce error rates, such as notifying record keepers of their error rates and the speed with which the errors are corrected, so that the record keepers can identify particular areas of improvement. Metrics may also be provided indicating how a particular record keeper performs compared to the body of record keepers as a whole, to inform record keepers of their performance relative to their peers.

In order to facilitate data gathering and correlation to improve search results, record data received by the search provider may be associated with particular metadata. For example, in addition to information describing the patient, each record may identify the provider, patient, payer, or the like that initiated the query, the geographic location of the record keeper, whether the record request is associated with an in-patient or out-patient visit, a type of medical specialization associated with the record keeper, insurance affiliations for the record keeper, and/or the like. This information may be processed and analyzed to assist with derivation of the record error analytics 216. Once the propagation delay has elapsed, the record data received by the record transfer system 202 may be sent to the other record keepers in the system.

FIG. 3 is an illustration of a record data flow 300 incorporating a propagation delay in accordance with example embodiments of the present invention. The data flow 300 depicts the process by which record data is provided by a record keeper to the record transfer system 202, but not propagated to other record keepers until a propagation delay has expired. At action 306, record data 304 is provided to the record transfer system 202. The record data 304 may be provided to the record transfer system 202 by any method, such as, but not limited to, a network message or an API function call. In some embodiments, the record data 304 may be provided by a HL7 admit-discharge-transfer (ADT) message. The message may also be associated with certain metadata, such as a priority (e.g., if the message contains urgent test results for a patient in surgery), information identifying the provider sending the message, or the like. Once the record transfer system 202 receives the record data 304, the record data may be stored in a queue 302 until a propagation delay expires. The stored record data 308 may be held by the record transfer system 202 to allow for any corrections or updates to the stored record data 308 before propagation of the record data 308 to other record keepers. At action 310, a determined propagation delay expires, and the record data 312 advances to the end of the queue. At the expiration of the delay, the record may be propagated to other record keepers at action 314.

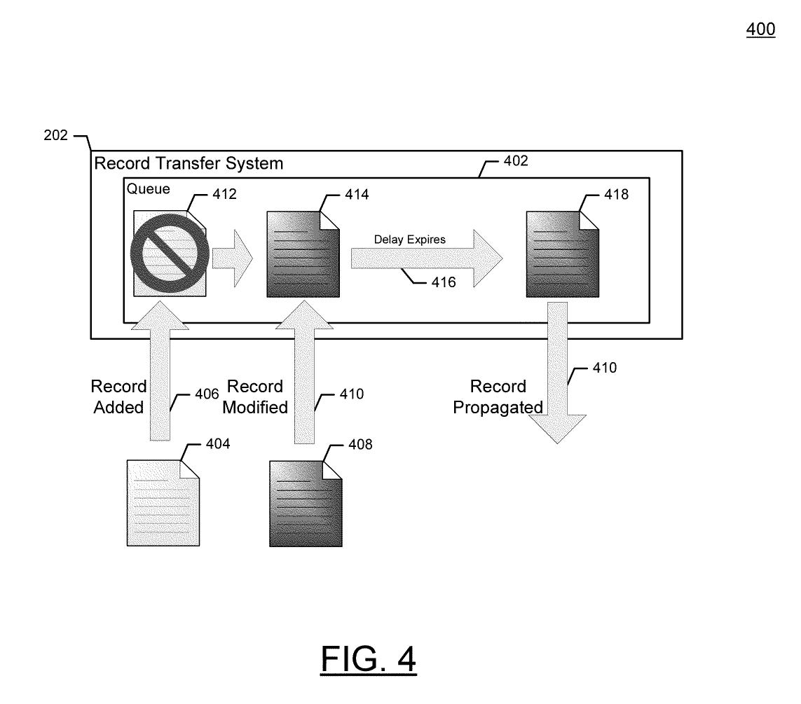

FIG. 4 is an illustration of a record data flow 400 involving a correction of a record in a system employing a propagation delay in accordance with example embodiments of the present invention. Similarly to the record data flow depicted with respect to FIG. 3, the record data flow 400 illustrates the process by which record data is subjected to a propagation delay prior to propagation to other record keepers coupled to the record transfer system. The record data flow 400 further depicts a process by which a record may be updated or replaced while in a queue 402 and prior to propagation to other record keepers.

At action 406, record data 404 is provided to the record transfer system 202. This record data 404 is stored in the queue 402 as the record data 408. However, before the propagation delay expires, a modification 408 to the record data is received at action 410. For example, a message correcting a patient name or diagnostic code associated with the original record data 404 may be received, or the original record data 404 may be replaced with a new set of record data. Since the previous record data 412 is still stored in the queue, this data may be replaced with the new record data 414 prior to propagation. This new record data may be propagated to other record keepers at action 410 after expiration of the delay.

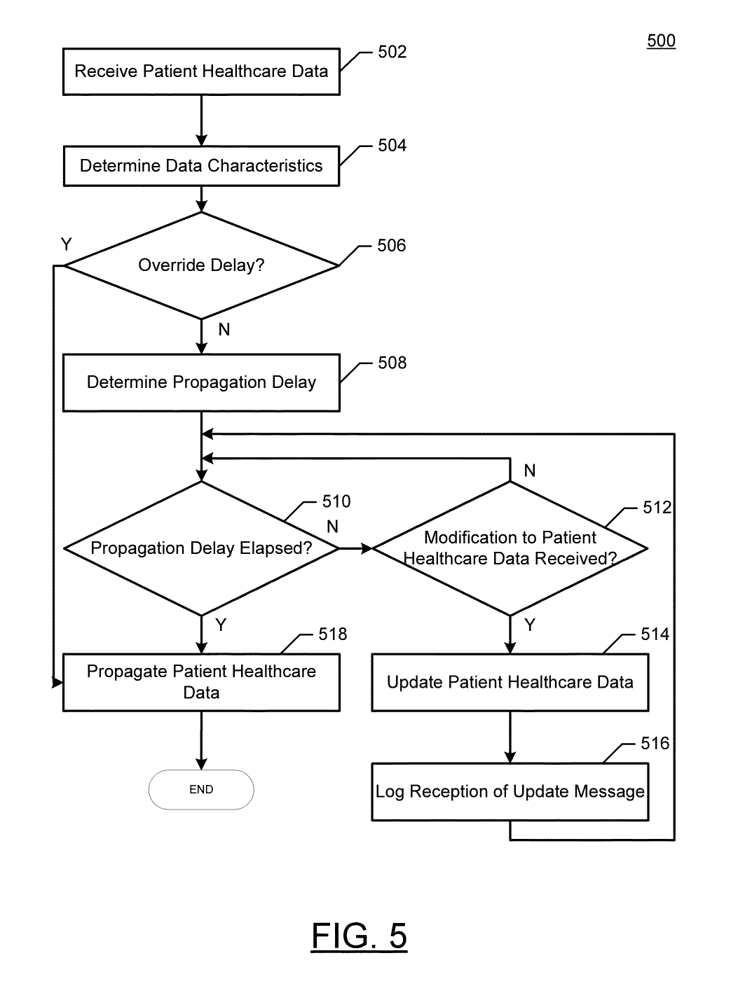

FIG. 5 is a flow diagram of an example of a method 500 for implementing a propagation delay in a medical record system in accordance with example embodiments of the present invention. The method 500 may function to receive healthcare record data and delay propagation of healthcare record data until a propagation delay period has expired. The method 500 may be further operable to identify circumstances where a propagation delay should be overridden, such as where record data is marked as urgent. Embodiments of the method 500 may be performed by an apparatus, such as the apparatus 102 described with respect to FIG. 1. In some embodiments, the method 500 may be employed by a record transfer system, such as the record transfer system 202 described with respect to FIG. 2.

At action 502, patient healthcare data is received. The patient healthcare data may include various forms of patient data, such as reports, letters, lab results, or any other type of patient healthcare data. This patient healthcare data may include requests to create new records or register new patients, or to modify, correct, or delete other patient records. In some embodiments, the patient healthcare data is received via a particular healthcare message protocol, such as according to the HL7 standards (e.g., an ADT message).

At action 504, characteristics of the healthcare data are determined. These characteristics may include features associated with the content of the data, the record keeper that provided the data, or the form and structure of the message itself. For example, these characteristics may include the identity of the provider the sent the patient healthcare data, the identity of the patient associated with the patient healthcare data, a priority flag associated with the message, the address of the patient or the record keeper, the medical specialty of the record keeper, whether the patient healthcare data pertains to a new patient registration, or the like. These characteristics may be included in the message itself by the sender of the patient healthcare data, or the characteristics may be derived by examining the source and content of the patient healthcare data.

At action 506, the method 500 may determine whether a propagation delay should be overridden. A set of patient healthcare data may have a flag marked as “priority” or “urgent”, and thus the propagation delay should be overridden and the healthcare data provided immediately. For example, the patient healthcare data may pertain to a set of lab results needed by a surgeon while the patient is undergoing a surgical procedure. In some embodiments, an override may be manually added by the record keeper providing the record. In some embodiments, an override may be dynamically determined based on the characteristics of the patient healthcare data. For example, if the patient healthcare data is flagged with an “urgent” flag, then the propagation delay may be overridden, or if the patient is known to be undergoing surgery at a particular time based on other records associated with the patient, then the propagation delay may be overridden. If the propagation delay is overridden, the method proceeds to action 518 at which the patient healthcare data is propagated. Otherwise, the method proceeds to action 508.

At action 508, a propagation delay is determined. As described above, the propagation delay may be a configurable timer that imposes a “cool off” period before patient healthcare data is propagated from a first record keeper to other record keepers. In this regard, the propagation delay may function to allow the record keeper that originally provided the patient healthcare data with an opportunity to correct or modify the patient healthcare data before the patient healthcare data is received by other record keepers, at which point it may be more difficult to correct any errors.

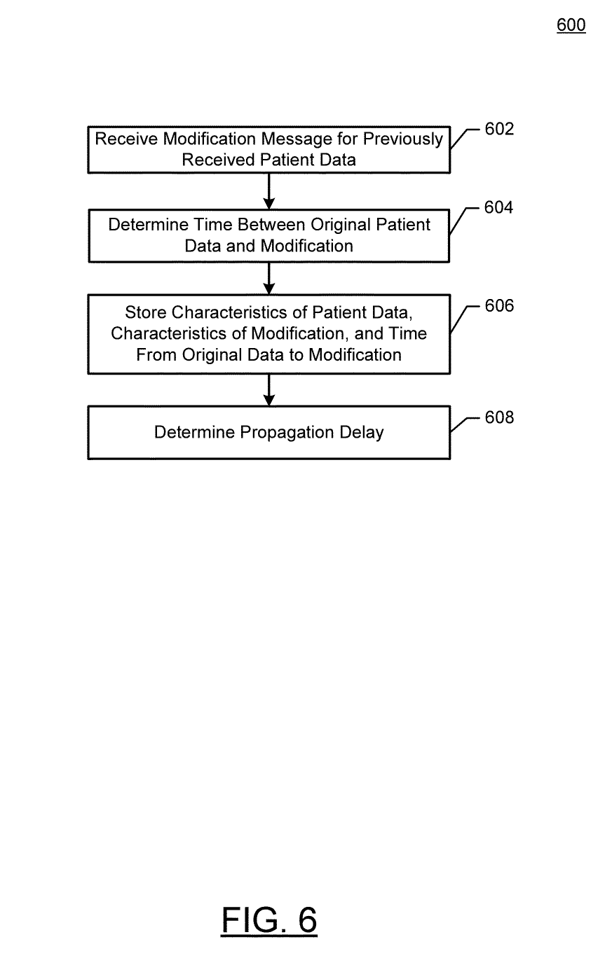

As described above, the propagation delay may be determined based on characteristics of the patient healthcare data. For example, record keepers that have higher rates of errors or longer delays in error correction may have a longer propagation delay imposed on records they create than record keepers that have few errors or shorter delays in error correction. The method 500 may configure the propagation delay for the characteristics of the particular set of patient healthcare data (e.g., providing record keeper, patient demographic information, type of patient healthcare data) and historical associations between those characteristics and an error frequency and/or correction delay. An example embodiment of a method for determining a propagation delay based on these characteristics is described below with respect to FIG. 6.

At action 510, the method determines whether the propagation delay has been met. If the propagation delay has not been met, then the method may enter a loop which periodically checks if any updates have been received to the patient medical data at action 512. Otherwise, once the propagation delay has been met, the method may proceed to propagate the patient healthcare data at action 518.

At action 512, the method determines whether any changes to the patient healthcare data have been received. These changes may include corrections to data in the patient healthcare data, updates to the patient healthcare data (e.g., adding additional information based on new test results), or deletion of the patient healthcare data. For example, detection of modifications to the patient healthcare data may involve monitoring for certain message types that indicate an update to previously provided healthcare data, such as an HL7 ADT message associated with an update or modification. If any changes are received, the method proceeds to action 514. Otherwise, the method returns to action 510, to continue the monitoring process until the propagation delay has been completed.

At action 514, the patient healthcare data is updated in accordance with the changes determined at action 512. This modification may include updating a copy of the patient healthcare data previously received by the method at action 502, or the previously received patient healthcare data may be replaced by new patient healthcare data that reflects the update received at action 512. In some embodiments, performing this update may reset the propagation delay for the patient healthcare data, while in other embodiments the record may be propagated as soon as the original propagation delay completed.

At action 516, the fact that an update or change was received for the patient medical data may be logged to assist with determination of future propagation delays. The log may include storing the characteristics of the patient healthcare data, along with the elapsed time between the reception of the patient healthcare data and the updated message. An example of a method for using logs of changes and/or corrections to determine propagation delays is provided below with respect to FIG. 6. After logging the update message, the method returns to action 510 to continue to delay propagation of the patient healthcare data until the propagation delay has elapsed.

FIG. 6 is a flow diagram of an example of a method 600 for determining a propagation delay in a medical record system in accordance with example embodiments of the present invention. As described with respect to FIGS. 2-5, embodiments may include a mechanism for determining a propagation delay for patient healthcare data based on historical data for corrections of patient healthcare data. In this regard, the propagation delay may be configured such that the propagation delay is likely to be long enough to capture corrections and modifications to patient healthcare data before the patient healthcare data is propagated to other record keepers. Embodiments of the method 600 may be performed by an apparatus, such as the apparatus 102 described with respect to FIG. 1. In some embodiments, the method 600 may be employed by a record transfer system, such as the record transfer system 202 described with respect to FIG. 2.

At action 602, the method receives a modification message for previously received patient healthcare data. As described above, this modification may include a request to modify, change, delete, or add to a set of patient healthcare data. The patient healthcare data may correspond to patient healthcare data that is queued by a record transfer system (e.g., data for which a propagation delay has not yet elapsed), or data that has already been propagated to other record keepers. An association of a particular modification message to a particular set of patient healthcare data may be provided explicitly within the message (e.g., a data field within the message indicating to which previously provided set of patient healthcare data the message is updating), or implicitly determined by the records transfer system (e.g., by identifying that the data within the patient healthcare data replaces or alters data previously provided by the same patient). The system may maintain a list of all correction messages (e.g., patient identity correction messages) to ensure that corrections are being properly applied to the appropriate patient records, and that correction messages are being applied in the proper order. In the event that correction messages from the same source do not explicitly relate to a particular record, those correction messages may be treated as applying to independent records, though the correction messages may still be used to calculate an appropriate propagation delay for the source.

At action 604, the elapsed time between when the previously provided patient healthcare data was received and when the modification message was received is determined. In this manner, the method 600 is operable to determine how long the record keeper took to identify and correct an error in the previously provided healthcare data.

At action 606, characteristics of the patient data (e.g., patient demographic information, provider information, the time of day the patient data was received, the type of the record), the modification message (e.g., which fields of the patient record were modified, which user performed the modification, what time of day the modification was received), and the elapsed time are stored, such as in a set of record correction analytics as described with respect to FIG. 2.

At action 608, a propagation delay may be determined based on the stored data. For example, a propagation delay may be determined in relation to a particular provider, a particular message type, a particular patient demographic characteristic, or based on a combination of factors. In some embodiments, machine learning techniques are used to establish dynamic weights for different characteristics to alter the impact that particular characteristics have on propagation delay calculation. The method 600 may determine a propagation delay to capture a minimum number of correction messages prior to propagation of the healthcare data. For example, the propagation delay for a particular record keeper may be set such that the propagation delay is long enough that 90% of all correction messages sent by the record keeper would have occurred during the period of the propagation delay if the propagation delay were applied to past patient healthcare data updates. As described above, different thresholds and propagation delays may be employed for different patient healthcare data, such that some sets of patient healthcare records have longer propagation delays than others. In some embodiments, the propagation delay may be dynamically determined for each set of patient record data based on the characteristics of that particular patient record, while in other embodiments propagation delays may be linked to particular characteristics (e.g., a single propagation delay for all patient healthcare data received from a particular record keeper).

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a set of patient healthcare data from a first record keeper;
determining at least one characteristic of the patient healthcare data;
determining, using a processor, a propagation delay for the patient healthcare data based on the at least one characteristic; and
propagating the set of patient healthcare data to at least one second record keeper after the propagation delay has expired.

2. The method of claim 1, further comprising:
receiving a modification to the set of patient healthcare data; and
modifying the set of patient healthcare data prior to propagating the patient healthcare data to the at least one second record keeper.

3. The method of claim 2, further comprising:
determining an elapsed time between receiving the set of patient healthcare data and receiving the modification to the set of patient healthcare data; and
storing the elapsed time.

4. The method of claim 3, further comprising using the elapsed time to determine a future propagation delay associated with a future set of patient healthcare data.

5. The method of claim 1, wherein the at least one characteristic comprises at least one of a characteristic of the first record keeper, a characteristic of a patient associated with the set of patient healthcare data, or a content type of the set of patient healthcare data.

6. The method of claim 1, further comprising:
determining that the set of patient healthcare data comprises an urgent notification; and
in response to determining that the set of patient healthcare data comprises an urgent notification, overriding the propagation delay to propagate the set of patient healthcare data before the propagation delay has elapsed.

7. The method of claim 1, wherein the propagation delay is determined based on at least one previous elapsed time between the reception of at least one previous set of patient healthcare data and at least one previous modification for the at least one previous set of patient healthcare data.

8. The method of claim 7, wherein the propagation delay is determined by calculating a minimum delay necessary to capture at least a threshold value of the previous modifications prior to propagation of the at least one previous set of patient healthcare data.

9. An apparatus comprising processing circuitry configured to:
receive a set of patient healthcare data from a first record keeper;
determine at least one characteristic of the patient healthcare data;
determine a propagation delay for the patient healthcare data based on the at least one characteristic; and
propagate the set of patient healthcare data to at least one second record keeper after the propagation delay has expired.

10. The apparatus of claim 9, further configured to:
receive a modification to the set of patient healthcare data; and
modify the set of patient healthcare data prior to propagating the patient healthcare data to the at least one second record keeper.

11. The apparatus of claim 10 further configured to:
determine an elapsed time between receiving the set of patient healthcare data and receiving the modification to the set of patient healthcare data; and
store the elapsed time.

12. The apparatus of claim 11, further configured to use the elapsed time to determine a future propagation delay associated with a future set of patient healthcare data.

13. The apparatus of claim 9, wherein the at least one characteristic comprises at least one of a characteristic of the first record keeper, a characteristic of a patient associated with the set of patient healthcare data, or a content type of the set of patient healthcare data.

14. The apparatus of claim 9, further configured to:
determine that the set of patient healthcare data comprises an urgent notification; and
in response to determining that the set of patient healthcare data comprises an urgent notification, override the propagation delay to propagate the set of patient healthcare data before the propagation delay has elapsed.

15. The apparatus of claim 9, wherein the propagation delay is determined based on at least one previous elapsed time between the reception of at least one previous set of patient healthcare data and at least one previous modification for the at least one previous set of patient healthcare data.

16. The apparatus of claim 15, wherein the propagation delay is determined by calculating a minimum delay necessary to capture at least a threshold value of the previous modifications prior to propagation of the at least one previous set of patient healthcare data.

17. A computer readable storage medium comprising instructions that, when executed by a processor, cause the processor to:
receive a set of patient healthcare data from a first record keeper;
determine at least one characteristic of the patient healthcare data;
determine a propagation delay for the patient healthcare data based on the at least one characteristic; and
propagate the set of patient healthcare data to at least one second record keeper after the propagation delay has expired.

18. The computer readable storage medium of claim 17, wherein the instructions further cause the processor to:
receive a modification to the set of patient healthcare data; and
modify the set of patient healthcare data prior to propagating the patient healthcare data to the at least one second record keeper.

19. The computer readable storage medium of claim 18, wherein the instructions further cause the processor to:
determine an elapsed time between receiving the set of patient healthcare data and receiving the modification to the set of patient healthcare data; and
store the elapsed time.

20. The computer readable storage medium of claim 19, wherein the instructions further cause the processor to use the elapsed time to determine a future propagation delay associated with a future set of patient healthcare data.
